(19) United States
(12) Patent Application Publication
(10) Pub. No.: US 2023/0094038 A1
(43) Pub. Date: Mar. 30, 2023

(54) SYSTEM AND METHOD FOR WATER BODY ALGAE CONTROL

(71) Applicant: Ronald Pote, Charleston, SC (US)

(72) Inventor: Ronald Pote, Charleston, SC (US)

(21) Appl. No.: 17/448,453

(22) Filed: Sep. 22, 2021

(51) Int. Cl. C02F 1/72; C02F 1/78; B01F 3/04; C02F 1/00

(52) U.S. Cl. CPC C02F 1/727; B01F 3/04106; C02F 1/008; C02F 1/78; C02F 2101/30

(57) ABSTRACT

A method and system for water body algae control are provided. The method for water body algae control may include the steps of: withdrawing water from the water body; infusing a gas containing oxygen and/or ozone into the withdrawn water by generating nanobubbles of the gas within the water; and returning the infused water into the water body. The water body algae control system may include a nanobubble generator that may be configured to receive water that is withdrawn from a water body. An oxygen concentrator and an air compressor may be configured to provide a gas containing oxygen to the nanobubble generator and/or to an ozone generator, in which the nanobubble generator is configured to disperse nanobubbles of the gas containing oxygen and/or ozone into the water, and in which the nanobubble containing water is then directed back into the water body.

### FIELD OF THE INVENTION

This patent specification relates to the field of water body algae control systems and methods. More specifically, this patent specification relates to a system and method for controlling algae growth in water bodies using nanobubble oxygen.

### BACKGROUND

Algae blooms are one of the most significant environmental issues affecting all types of water bodies today. They impact recreation use of lakes and ponds, drinking water sources, and contribute to health problems when humans and animals contact some of the algal species that release toxic compounds into the water and surrounding air.

Various forms of green and blue green (cyanobacteria) algae are naturally present in most water bodies such as lakes and ponds. These algae can be beneficial to aquatic life in small quantities as fish and other animals consume algae as a food source. Algae are plants that utilize photosynthesis to live. They produce oxygen during the daytime hours, using solar energy to convert carbon dioxide in the atmosphere into oxygen needed for respiration. This generates dissolved oxygen (DO) in the upper portions of the water body where sunlight can penetrate vertically into the water column and algae are present.

The algae receive nutrients such as phosphorus and nitrogen, that are required by the plants for survival, from the water column and from the bottom of the water body. These nutrients are in higher concentrations as surface runoff, fertilizer deposition, and other contributors are washed into the water body over time. Anaerobic conditions in the sediment layer in the bottom of the water body favor release of these nutrients into the water column where they are made available for the algae plants in the upper portion of the water column.

DO levels increase and decrease in the upper portions of the water column based on the action of algae and physical factors such as wave actions that entrain oxygen in the surface water. At night, or on cloudy days when sunlight is not abundant, algae consume DO and release carbon dioxide to the water column. If DO levels are sufficiently depleted by algae, negative impacts on aquatic life such as fish kills can occur as free oxygen is no longer available to sustain life.

Control of various types of algae, in particular blue green algae (also known as cyanobacteria) and harmful algal blooms (HABs), in water bodies may be conducted by applying various chemicals to damage or kill the algae plants. These include copper sulfates (algaecides) and oxidizing chemicals such as hydrogen peroxide, peroxyacetic acids, and chlorine compounds. Many of these chemicals can cause health impacts to humans and animals that utilize the water from the pond or lake. These chemicals may also cause unwanted side effects on water quality or eventual use of the water in the water bodies for irrigation or other purposes. Additionally, when water from the water body is applied to soil via irrigation methods, negative impacts can be created that decrease microbial life in the soil.

Therefore, a need exists for novel water body algae control systems and methods. A further need exists for novel water body algae control systems and methods that do not utilize chemicals can cause health impacts to humans and animals that use the water. There is also a need for novel water body algae control systems and methods that do not cause the water of the water body to negatively impact soil microbial life, such as when used for irrigation purposes.

### BRIEF SUMMARY OF THE INVENTION

A method and system for water body algae control is provided. The method and system may be used to provide nanobubbles of an oxygen containing gas and/or an ozone containing gas into a water body which will quickly react with algae and other organic contaminants. Preferably, the nanobubbles may increase aerobic conditions in the bottom of the water body, and bioaugmentation and biostimulation products may be utilized to increase microbial activity to consume nutrients such as phosphorus and nitrogen and reduce access of these nutrients to the algae plants in the upper portions of the water bodies, thus limited algal growth. Preferably, ozone nanobubbles may be formed along with oxygen nanobubbles and may be effective in oxidizing algal cells and other water contaminants. Ozone nanobubbles break down into oxygen and water - providing oxidation without harsh chemicals.

In some embodiments, a method for water body algae control in a water body may include the steps of: withdrawing water from the water body; infusing a gas containing oxygen and/or ozone into the withdrawn water by generating nanobubbles of the gas within the water; and returning the infused water into the water body.

In some embodiments, a water body algae control system may include a nanobubble generator that may be configured to receive water that is withdrawn from a water body. An oxygen concentrator and an air compressor may be configured to provide a gas containing oxygen and/or an ozone generator may be configured to provide a gas containing ozone to the nanobubble generator. The nanobubble generator may be configured to disperse nanobubbles of the gas containing oxygen and/or a gas containing ozone into the water, and in which the nanobubble containing water is then returned back into the water body.

According to one aspect consistent with the principles of the invention, the system may comprise and/or the method may utilize a portable platform mounted on wheels which may be include an oxygen generation system preferably including an air compressor and an oxygen concentrator, an ozone generator, a nanobubble generation unit, monitoring and control equipment and associated plumbing which may be towed or otherwise moved to be proximate to a water body and/or a desired location along the water body.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a schematic diagram of an example of a water body algae control system according to various embodiments described herein.

FIG. 2 illustrates a block diagram showing some exemplary electrically operated components of a water body algae control system according to various embodiments described herein.

FIG. 3 shows a block diagram of an example of a control unit according to various embodiments described herein.

FIG. 4 depicts a schematic diagram of electronic communication between an example water body algae control system and one or more client devices and servers according to various embodiments described herein.

FIG. 5 illustrates block diagram of an example of a method for water body algae control according to various embodiments described herein.

FIG. 6 shows a perspective view of an example of a water body algae control system that includes a movable platform according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

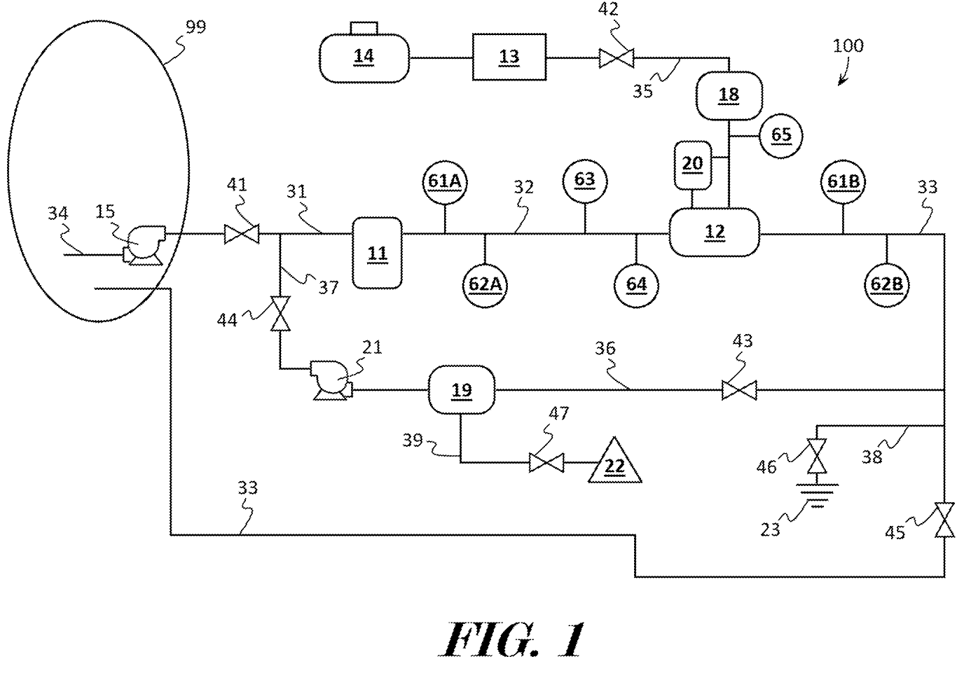

For purposes of description herein, the terms “upper,” “lower,” “left,” “right,” ”rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new system and method for water body algae control is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIG. 1 illustrates an example of a water body algae control system (“the system”) 100 according to various embodiments. In some embodiments, the system 100 may comprise a first conduit 31 which may receive water from a water body 99, such as a pond, lake, reservoir, etc., and communicate the received water to a filter unit 11 which may remove contaminants from the water. A second conduit 32 may communicate the water from the filter unit 11 to a nanobubble generator 12. An oxygen concentrator 13 and an air compressor 14 may provide a gas containing oxygen and/or an ozone generator 20 may provide a gas containing ozone to the nanobubble generator 12 which may then disperse nanobubbles of the gas containing oxygen and/or the gas containing ozone into the water. A third conduit 33 may then communicate the nanobubble containing water back into the water body 99, and more preferably communicate the nanobubble containing water back into the bottom of the water body 99. Water may be motivated through the system 100 via an intake pump 15. The system may include one or more sensors, such as a dissolved oxygen (DO) sensor 61A, 61B, oxidation reduction potential (ORP) sensor 62A, 62B, flow sensor 63, temperature sensor 64, pressure sensor 65, etc., which may measure the water flowing through one or more of the conduits 31, 32, 33. The sensors 61, 62, 63, 64, 65, nanobubble generator 12, oxygen concentrator 13, air compressor 14, and pump 15, may be in communication with a control unit 50 through which system data and functions may be monitored and controlled, optionally via a remote client device 400.

The system 100 may comprise one or more intake pumps 15 which may be configured to draw water from a water body 99 into the system 100, through the system 100, and ultimately out of the system 100 to be returned to the water body 99. In preferred embodiments, an intake pump 15 may comprise a submersible pump so that the intake pump 15 may be positioned on the bottom of the water body 99 to allow the pump 15 to intake water from the bottom of the water body 99. In further embodiments, an intake pump 15 may be coupled to a fourth conduit 34 which may be positioned on the bottom of the water body 99 to allow the pump to intake water from the bottom of the water body 99 through the fourth conduit 34. Generally, the bottom of a water body 99 may refer to any depth greater than approximately three feet below the surface of the water body 99.

An intake pump 15 may comprise a hydraulic pump, such as a gear pump, rotary vane pump, screw pump, bent axis pump, inline axial piston pumps and swashplate principle pumps, displacement pumps, radial piston pumps, peristaltic pumps, or any other suitable type of fluid motivating pump. In preferred embodiments, a pump 15 may be interlocked to operate when the gas containing oxygen that is provided to the nanobubble generator 12 has a gas pressure at a minimum of approximately 10 pounds per square inch which may be measured by a pressure sensor 65.

The system 100 may comprise one or more filter units 11 which may be configured to filter and remove particulate matter and other contaminates from water that is drawn into the system 100, such as to protect a nanobubble generator 12 and/or other elements of the system 100. In preferred embodiments, a filter unit 11 may be coupled to a secondary conduit 32 between an intake pump 15 and a nanobubble generator 12 so that the filter unit 11 is configured remove contaminants from the water that is withdrawn from a water body 99 before it is received by the nanobubble generator 12. In further embodiments, a filter unit 11 may be integrated with an intake pump 15, coupled to a fourth conduit 34 so as to filter water before it enters an intake pump 15, and/or positioned anywhere else in the system 100. A filter unit 11 may comprise a device or method suitable for filtering and removing particulate matter and other contaminates from water. In preferred embodiments, a filter unit 11 may comprise a screen 16, such as a stainless-steel mesh or wire screen, which may be removable and/or replaceable so as to allow the screen to be cleaned, replaced, exchanged, etc.

The system 100 may comprise one or more nanobubble generators 12 which may receive water from the water body 99 via a second conduit 32. Preferably, a nanobubble generator 12 may be configured to generate oxygen and/or ozone nanobubbles in water passing through it that may be sized less than approximately 800 nanometers (nm), more preferably sized less than approximately 500 nanometers (nm), and more preferably sized less than approximately 200 nanometers (nm). Preferably, a nanobubble generator 12 may also be configured to generate nanobubbles in water passing through it at concentrations over approximately 1.0 x 10^5 nanobubbles per milliliter , and more preferably at concentrations over approximately 1.0 x 10^8 nanobubbles per milliliter.

In preferred embodiments, a nanobubble generator 12 may comprise a membrane unit that is constructed of a hollow porous ceramic membrane material. The nanobubble generator 12 may have a gas input fitting to direct gas containing oxygen provided to the nanobubble generator 12 into the center of the hollow ceramic membrane material. The membrane material may be in contact with the water provided to the nanobubble generator 12, and pressurized gas containing oxygen may be forced through the membrane material thereby generating nanobubbles in the water. The ceramic membrane material may be encased in a metal or plastic structure that provides connections to piping of incoming water, via second conduit 32, and outgoing water, via third conduit 33, from the nanobubble generator 12. Preferably, the pressure of the gas containing oxygen supplied to the nanobubble generator 12 may exceed water pressure in the nanobubble generator 12 by a minimum of 10 PSI differential gas pressure.

In preferred embodiments, a nanobubble generator 12 may comprise a membrane unit that is constructed of a hollow cavitation unit. The nanobubble generator 12 may have a gas input fitting to direct gas containing oxygen provided to the nanobubble generator 12 into the center of the hollow cavitation unit. The cavitation unit may be in contact with the water provided to the nanobubble generator 12, and pressurized gas containing oxygen may be forced into the cavitation unit thereby generating nanobubbles in the water. The cavitation unit may be constructed with metal or plastic that provides connections to piping of incoming water, via second conduit 32, and outgoing water, via third conduit 33, from the nanobubble generator 12. Preferably, the pressure of the gas containing oxygen supplied to the nanobubble generator 12 may exceed water pressure in the nanobubble generator 12 by a minimum of 10 PSI differential gas pressure.

In some embodiments, the system 100 may comprise an oxygen concentrator 13 and an air compressor 14 that may be configured to provide gas containing oxygen to the nanobubble generator 12. Gas containing oxygen provided to the nanobubble generator 12 may be generated using atmospheric air with an air-to-air compressor 14 unit. This compressed air may then be directed to a pressure swing absorption unit (PSA) type of oxygen concentrator 13 which may remove the nitrogen portion of the air and produce a gas containing oxygen having oxygen gas at a concentration of greater than approximately 90 percent by volume, more preferably at a concentration of greater than approximately 93% by volume, and still more preferably at a concentration of greater than approximately 95% by volume. In other embodiments, any other suitable device or method may be used to generate oxygen gas that may be supplied to a nanobubble generator 12.

In some embodiments, the system 100 may include a receiver tank 18 which may store gas containing oxygen generated by an oxygen concentrator 13 and air compressor 14. A receiver tank 18 may comprise any vessel suitable for storing and dispensing a compressed gas, such as oxygen. In preferred embodiments, the gas containing oxygen may be stored in a receiver tank 18 that may supply the nanobubble generator 12 with a pressured gas flow that is generally operated at approximately 15 to 40 PSI pressure.

In some embodiments, the system 100 may include an ozone generator 20 with may be configured to generate a gas containing ozone that may be supplied to a nanobubble generator 12. Generally, ozone generators produce ozone by breaking apart oxygen molecules into single atoms, which then attach to other oxygen molecules in the air to form ozone. Preferably, an ozone generator 20 may receive a portion of gas containing oxygen produced by an oxygen concentrator 13, and the ozone generator 20 may use that portion of the gas containing oxygen to produce ozone. An ozone generator 20 may comprise any suitable device or method for generating a gas containing ozone. In preferred embodiments, an ozone generator 20 may comprise a corona discharge type of ozone generator that may use electric discharge to produce ozone by splitting the oxygen molecules in the air into single atoms. These atoms then attach to other oxygen molecules in the air to form ozone. In further embodiments, an ozone generator 20 may comprise an Ultraviolet radiation type of ozone generator that may use ultraviolet radiation to split oxygen to form individual oxygen atoms.

In some embodiments, the system 100 may comprise one or more dissolved oxygen (DO) sensors 61A, 61B. A DO sensor 61A, 61B, may comprise a sensor that is configured to determine or measure the amount of dissolved oxygen in water in the system 100 and which may be positioned anywhere in the system 100. In preferred embodiments, the system 100 may comprise a first DO sensor 61A which may measure the amount of dissolved oxygen in water passing into the nanobubble generator 12 via the second conduit 32 and/or a second DO sensor 61B which may measure the amount of dissolved oxygen in water exiting the nanobubble generator 12 via the third conduit 33. A DO sensor 61A, 61B, may comprise any suitable device or method for measuring dissolved oxygen in water. For example, a DO sensor 61A, 61B, may comprise an electrochemical DO sensor, dissolved oxygen diffuses from the sample across an oxygen permeable membrane and into the sensor. Once inside the sensor, the oxygen undergoes a chemical reduction reaction, which produces an electrical signal. Example DO sensors 61A, 61B, may also include Galvanic dissolved oxygen sensors, Polarographic dissolved oxygen sensors, and Optical dissolved oxygen sensors.

In some embodiments, the system 100 may comprise one or more oxidation reduction potential (ORP) sensors 62A, 62B. An ORP sensor 62A, 62B, may comprise a sensor that is configured to determine or measure the oxidation reduction potential of water in the system 100 and which may be positioned anywhere in the system 100. Generally, an ORP sensor 62A, 62B, measures the ability of a solution to act as an oxidizing or reducing agent. In preferred embodiments, the system 100 may comprise a first ORP sensor 62A which may measure the oxidation reduction potential of water passing into the nanobubble generator 12 via the second conduit 32 and/or a second DO sensor 61B which may measure the oxidation reduction potential of water exiting the nanobubble generator 12 via the third conduit 33. An ORP sensor 62A, 62B, may comprise any suitable device or method for measuring the ability of a solution to act as an oxidizing or reducing agent. For example, an ORP sensor 62A, 62B, may operate by measuring the potential of a chemically-inert (platinum) electrode which is immersed in the solution. The sensing electrode potential may be read relative to the reference electrode of the pH probe and the value is presented in millivolts (mV).

In some embodiments, the system 100 may comprise one or more flow sensors 63 which may be positioned anywhere in the system 100 and which may be configured to measure the speed of water moving past the flow sensors 63 in a conduit. In preferred embodiments, the system 100 may comprise a flow sensor 63 which may measure the speed of water moving past the flow sensors 63 in the second conduit 32. In some embodiments, a flow sensor 63 may comprise a turbine flow meter which may measure the speed of water by measuring the speed at which the water rotates a turbine positioned in the water. In other embodiments, a flow sensor 63 may comprise a differential pressure flow meter, an orifice plate flow meter, a venture tube flow meter, a flow nozzle flow meter, a variable area flow meter or rotameter, a velocity flow meter, a pilot tube flow meter, a calorimetric flow meter, a vortex flow meter, an electromagnetic flow meter, an ultrasonic Doppler flow meter, a positive displacement flow meter, a mass flow meter, a thermal flow meter, a Coriolis flow meter, an open channel flow meter, or any other suitable device which is able to measure the speed of water.

In some embodiments, the system 100 may comprise one or more temperature sensors 64 which may be configured to measure the temperature of water in a conduit and which may be positioned anywhere in the system 100. In preferred embodiments, the system 100 may comprise a temperature sensor 64 which may measure the temperature of water in the second conduit 32. A temperature sensor 64 may comprise a thermocouple, a resistive temperature device (RTDs, thermistors), an infrared temperature sensor, a bimetallic device, a liquid expansion device, a molecular change-of-state device, a silicon diode, or any other type of temperature sensor configured to generate temperature information.

In some embodiments, the system 100 may comprise one or more pressure sensors 65 which may be positioned anywhere in the system 100. In preferred embodiments, the system 100 may comprise a pressure sensor 65 which may measure the pressure of the gas containing oxygen supplied to a nanobubble generator 12 via a fifth conduit 35. A pressure sensor 65 may include silicon MEMS strain gauge sensors; pressure sensor piezoresistive silicon pressure sensors; analog output pressure transducer sensors; remote wireless pressure transducers; harsh media pressure sensors; digital output absolute pressure sensors; IsoSensor type pressure sensors; solid state pressure sensors; or any other type of pressure sensing method or device.

Fluid communication between the elements of the system 100 and a water body 99 may be provided via conduits 31 – 39. Water and liquid bearing conduits 31 – 34, 36 – 39 may comprise any type of pipe or conduit suitable for contacting water, such as Poly Vinyl Chloride (PVC) pipe, Chlorinated Poly Vinyl Chloride (CPVC) pipe, cross-linked polyethylene (PEX) pipe, galvanized pipe, black pipe, polyethylene pipe, copper pipe, brass pipe, stainless steel or other steel alloy pipe, vinyl pipe, or any other type of suitable pipe or conduit. Gas and pressurized gas conduits 35 may comprise any type of pipe or conduit suitable for contacting pressurized gas and pressurized oxygen containing gas, such as copper pipe, stainless steel pipe, aluminum pipe, polyurethane air hose, PVC air hose, blend of polyurethane, PVC and rubber air hose or any other type of suitable pipe or conduit.

In some embodiments, the system 100 may comprise one or more valves 41 – 47. Valves the system 100 may comprise one or more valves which may enable, disable, and modulate the fluid communication in one or more conduits 31 – 39. A valve 41 – 47 may comprise a flow control valve, pressure regulating valve, relief valve, ball valve, a gate valve, butterfly valve, diaphragm valve, needle valve, globe valve, check valve, pressure balanced valve, locking valve, solenoid valve, or any other type of valve or controller which may be used to enable, disable, or otherwise modulate the flow of water and/or gasses to or through one or more elements or components of the system 100. In some embodiments, one or more of these valves 41 – 47 may be a manually operated valve so that the valve may be manually opened or closed by a user 101. In further embodiments, one or more of these valves 41 – 47 may be an automated valve so that the valve may be opened or closed without physical interaction of a user 101 with the valve 41 – 47.

In some embodiments, the system 100 may comprise a clean-in-place tank 19 and a clean-in-place pump 21 which may be used to provide an automated method of cleaning the interior surfaces of pipes, tanks, lines, process equipment, and associated fittings without requiring the operator to disassemble the equipment. A clean-in-place tank 19 may be configured as a once-through or re-circulated source of cleaning solution and rinse water, and a clean-in-place pump 21 may comprise any suitable hydraulic pump which may be suitable for moving cleaning solution and rinse water through the system 100. When the system 100 is being used for water body algae control, a first valve 41 and a fifth valve 45 may be open to allow water to flow through the first 31, second 32, and third 33 conduits, while a third 43, fourth 44, sixth 46, and seventh 47 valve may remain closed. When the system 100 is cleaned, a first valve 41 and a fifth valve 45 may be closed, while a third 43, and fourth 44 valve may be open to enable cleaning solution and water to be circulated through the first 31, second 32, and third 33 conduits. Optionally, fresh water may be added to the system 100 via a sixth valve 46 that may be in communication with a fresh water or other water source 22, and a seventh valve 47 may be operable to enable water to leave the system 100 via a drain 23.

In some embodiments, the system 100 may comprise a power source 81. Preferably, electrical power to the system 100 may be provided by two input power lines using 110 volt alternating current (VAC) power. One power line may be utilized to power the portable platform system which consists of the oxygen generation unit(s), monitoring system, cooling system, LED lighting, and other power needs. Another, separate power input line may be utilized to provide power to the intake pump 15. This power supply may be interlocked to operate only if adequate gas containing oxygen pressure is present in the nanobubble generator system 12 as to prevent damage to the nanobubble generator ceramic membrane. Optionally, a power source 81 may comprise an extended power cord on a retractable reel device and separated into system power and pump power inputs in the portable platform 71. In further embodiments, a power source 81 may comprise a combustion powered electrical generator, a solar powered electrical generator, or any other suitable device of method for supplying power to one or more elements of the system 100.

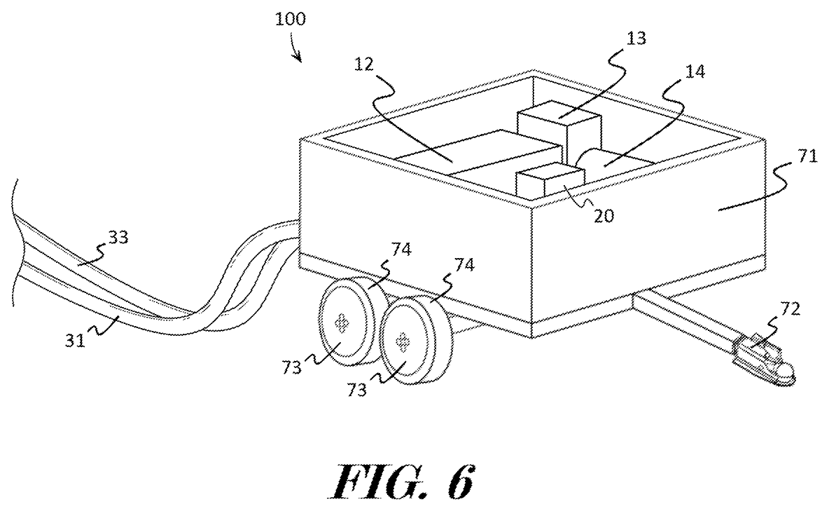

In some embodiments, one or more elements of the system 100 may be coupled or mounted on a portable platform 71 having a ball-mounted hitch 72. In preferred embodiments, the nanobubble generator 12, oxygen concentrator 13, and air compressor 14 may be coupled to a portable platform 71 having a ball-mounted hitch 73. Preferably, a portable platform 71 may be configured as a trailer which may be supported above a ground surface via one or more wheels 73and tires 74, and the portable platform 71 may be towed by a vehicle using the ball-mounted hitch 72. In the example of FIG. 6, the portable platform 71 is configured as an open trailer so that the nanobubble generator 12, oxygen concentrator 13, and air compressor 14 may be viewed. However, it should be understood that a portable platform 71 may be configured as an enclosed trailer having one or more access doors, a wheel-less platform that may be lifted into place, a self-propelled tracked vehicle, or any other configuration which may hold, position, or otherwise support one or more elements of the system 100. Optionally, a portable platform 71 may include one or more cooling fans, vents, windows, etc., which may be configured to maintain internal temperature below 112° F.

In some embodiments, one or more of the elements that comprise the system 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the system 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the system 100 may be coupled by being one of connected to and integrally formed with another element of the system 100.

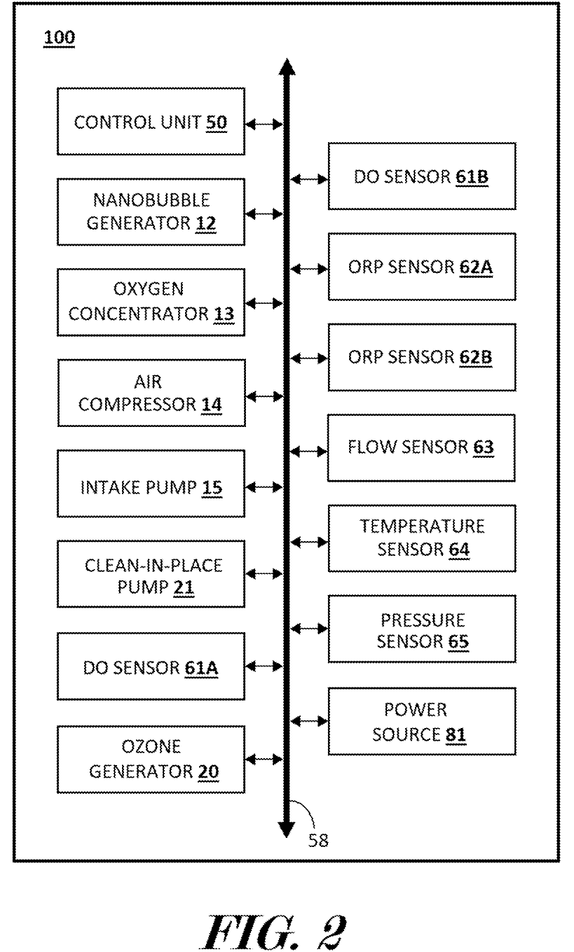

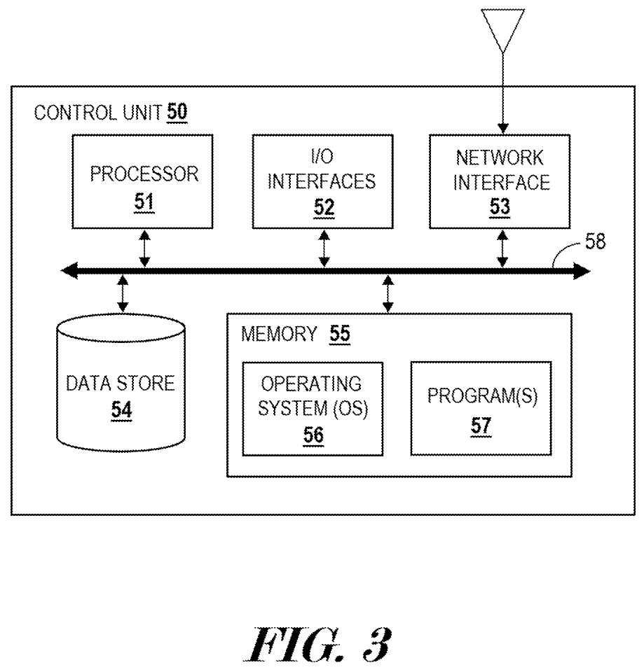

As shown in FIGS. 2 and 3, the system 100 may comprise a control unit 50 which may be in electronic communication one or more electronic components of the system 100, such as a nanobubble generator 12, oxygen concentrator 13, air compressor 14, intake pump 15, clean-in-place pump 21, dissolved oxygen (DO) sensors 61A, 61B, oxidation reduction potential (ORP) sensors 62A, 62B, flow sensor 63, temperature sensor 64, and pressure sensor 65. Optionally, one or more valves 41 – 47 may be electronically operated and the control unit 50 which may be in electronic communication with them. In some embodiments and in the present example, the control unit 50 can be a digital device that, in terms of hardware architecture, optionally includes a processor 51, input/output (I/O) interfaces 52, a radio module 53, a data store 54, and memory 55. It should be appreciated by those of ordinary skill in the art that FIG. 3 depicts the control unit 50 in an oversimplified manner, and a practical embodiment may include additional components or elements and suitably configured processing logic to support known or conventional operating features that are not described in detail herein.

The control unit 50 components and elements (12, 13, 14, 15, 21, 61A, 61B, 62A, 62B, 63, 64, 65) are communicatively coupled via one or more local interfaces 58. A local interface 58 can be, for example but not limited to, one or more buses, circuit boards, wiring harnesses, or other wired connections or wireless connections, as is known in the art. The local interface 58 can have additional elements, which are omitted for simplicity, such as controllers, buffers (caches), drivers, repeaters, and receivers, among many others, to enable communications. Further, the local interface 58 may include address, control, and/or data connections to enable appropriate communications among the aforementioned components.

The processor 51 is a hardware device for executing software instructions. The processor 51 can be any custom made or commercially available processor, a central processing unit (CPU), an auxiliary processor among several processors associated with the control unit 50, a semiconductor-based microprocessor (in the form of a microchip or chip set), or generally any device for executing software instructions. When the control unit 50 is in operation, the processor 51 is configured to execute software stored within the memory 55, to communicate data to and from the memory 55, and to generally control operations of the system 100 pursuant to the software instructions and/or from instructions received from a user 101 or a client device 400. In an exemplary embodiment, the processor 51 may include a mobile optimized processor, such as optimized for power consumption and mobile applications.

The I/O interfaces 52 can be used to by a user 101 to provide user input and display system output data, such operational status, from the system 100. The I/O interfaces 52 can include, for example, buttons, knobs, switches, LED indicator lights, LED display, LCD display, a serial port, a parallel port, a small computer system interface (SCSI), an infrared (IR) interface, a radio frequency (RF) interface, a universal serial bus (USB) interface, and the like. In some embodiments, I/O interfaces 52 may comprise buttons, knobs, switches, etc., that may be manipulated by a user 101 to enable the user 101 to select one or more settings for nanobubble generator 12, oxygen concentrator 13, air compressor 14, intake pump 15, clean-in-place pump 21, valves 41 – 47, etc., of the system 100.

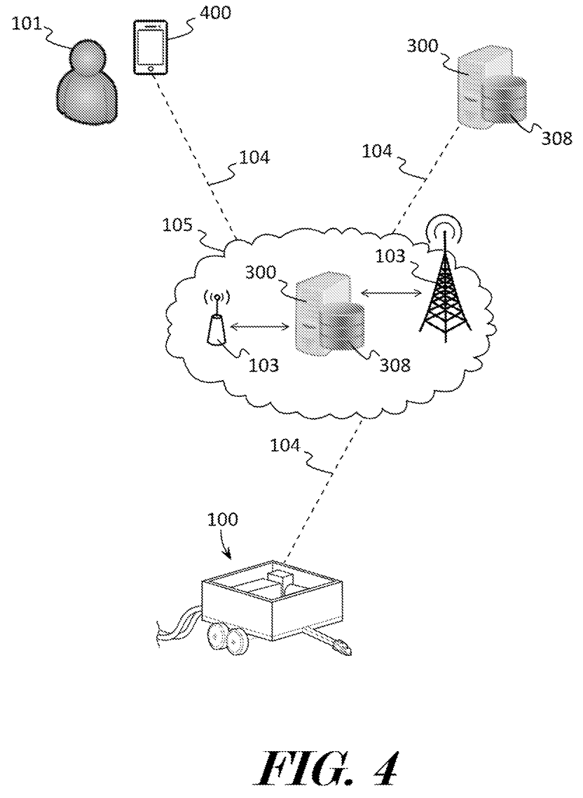

A network interface 53 enables wireless and/or wired communication to an external access device, such as a client device 400, server 300, network 105, etc., as shown in FIG. 4. Preferably, the network interface 53 may enable the system 100 to transfer data and information between one or more access points 103, client devices 400, and servers 300 over a data network 105. Typically, client devices 400, such as smartphones, tablet computers, laptop computers, desktop or workstation computers, etc., may send data to and receive data from the data network 105 through a network connection 104 with an access point 103. A data store 308 accessible by the server 300 may contain one or more databases which may store data recorded by a control unit 50 describing the functions and readings of one or more components of the system 100. A network interface 53 may enable remote access for a user 101 to monitoring sensor 61A, 61B, 62A, 62B, 63, 64, 65, data and other system 100 data that may be provided via a cloud-based telemetry or other means for monitoring and historical collection of this data.

A network interface 53 may enable a user 101 to provide user input to the system 100 and to receive system 100 status data via a client device 400, such as a smartphone, tablet computer, laptop computer, desktop or workstation computer, etc., to enable the user 101 to select or view one or more settings for nanobubble generator 12, oxygen concentrator 13, air compressor 14, intake pump 15, clean-in-place pump 21, valves 41 – 47, etc., of the system 100. In this manner, the control unit 50 may be configured to receive user input via a client device 400 that is in electronic communication with the network interface 53. As an example, one or more functions of a nanobubble generator 12, oxygen concentrator 13, air compressor 14, intake pump 15, clean-in-place pump 21, valves 41 – 47, etc., and one or more readings or measurements from dissolved oxygen (DO) sensors 61A, 61B, oxidation reduction potential (ORP) sensors 62A, 62B, flow sensor 63, temperature sensor 64, and pressure sensor 65 may be controlled, viewed, and maintained via a web browser, web portal, smartphone application, etc., of a client device 400 that is in communication with a network interface 53 of the system 100. In preferred embodiments, the control unit 50 may be in communication with the dissolved oxygen (DO) sensors 61A, 61B, oxidation reduction potential (ORP) sensors 62A, 62B, flow sensor 63, temperature sensor 64, and pressure sensor 65 of the system 100, and the control unit 50 may be configured to communicate data describing the readings or measurements from the dissolved oxygen (DO) sensors 61A, 61B, oxidation reduction potential (ORP) sensors 62A, 62B, flow sensor 63, temperature sensor 64, and pressure sensor 65 to a client device 400 that is in communication with the network interface 53 of the control unit 50.

In preferred embodiments, a network interface 53 may operate via WiFi communication standards. In further embodiments, a network interface 53 may operate on a cellular band and may communicate with or receive a Subscriber Identity Module (SIM) card or other wireless network identifier. Any number of suitable wireless data communication protocols, techniques, or methodologies can be supported by the network interface 53, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

An optional data store 54 may be used to store data. The data store 54 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 54 may incorporate electronic, magnetic, optical, and/or other types of storage media.

The memory 55 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 55 may incorporate electronic, magnetic, optical, and/or other types of storage media. Note that the memory 55 may have a distributed architecture, where various components are situated remotely from one another, but can be accessed by the processor 51. The software in memory 55 can include one or more software programs, each of which includes an ordered listing of executable instructions for implementing logical functions. In the example of FIG. 3, the software in the memory system 55 includes a suitable operating system (O/S) 56 and program(s) 57. The operating system 56 essentially controls the execution of input/output interface 52 and other element functions, and provides scheduling, input-output control, file and data management, memory management, and communication control and related services. The operating system 56 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 57 may include various applications, add-ons, etc. configured to provide end user functionality of the system 100. In a typical example, one or more of the programs 57 may comprise instructions for controlling the functions of nanobubble generator 12, oxygen concentrator 13, air compressor 14, intake pump 15, clean-in-place pump 21, valves 41 – 47, etc., preferably using data measurements and readings that may be recorded by one or more sensors 61A, 61B, 62A, 62B, 63, 64, 65, of the system 100.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The control unit 50 may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by the processor 51. In addition, the main memory may be used for storing temporary variables or other intermediate information during the execution of instructions by the processor 51. The control unit 50 may further include a read only memory (ROM) or other static storage device (e.g., programmable ROM (PROM), erasable PROM (EPROM), and electrically erasable PROM (EEPROM)) coupled to the bus for storing static information and instructions for the processor 51.

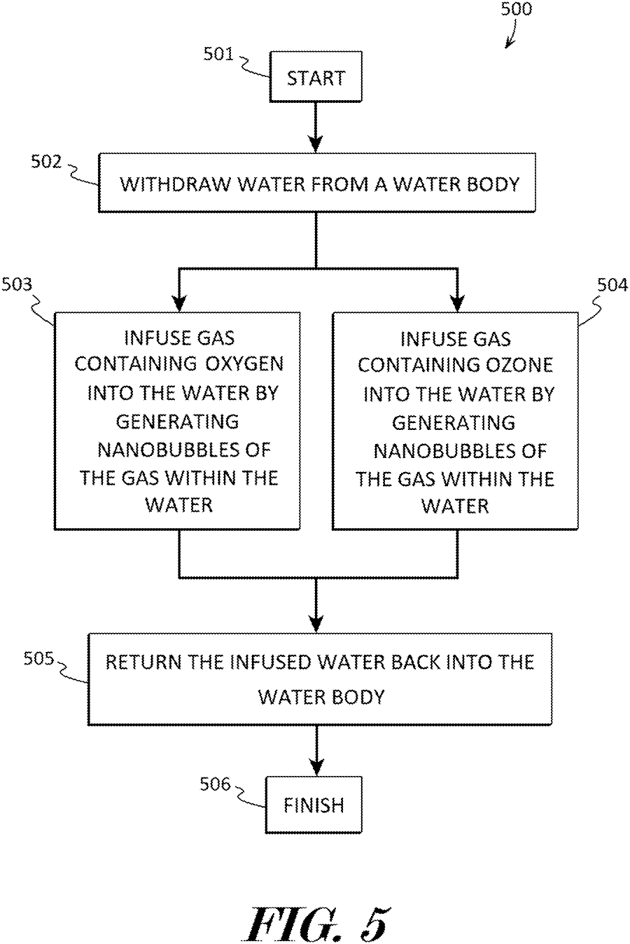

FIG. 5 illustrates a block diagram of a method for water body algae control in a water body (“the method”) 500. In preferred embodiments, the steps of the method 500 may be performed by a water body algae control system 100.

In some embodiments, the method 500 may start 501 and water may be withdrawn from a water body 99 in step 502. In some embodiments, water may be withdrawn from a water body 99 via an intake pump 15 that may comprise a submersible pump so that the intake pump 15 may be positioned underwater in the water body 99, and more preferably on the bottom of the water body 99 to allow the intake pump 15 to intake water from the bottom of the water body 99. In further embodiments, water may be withdrawn from a water body 99 via an intake pump 15 that may be coupled to a conduit (fourth conduit 34 in FIG. 1) which may be positioned on the bottom of the water body 99 to allow the intake pump 15 to intake water from the bottom of the water body 99 through the fourth conduit 34.

After step 502, the method may proceed to step 503 and/or to step 504.

In step 503, a gas containing oxygen may be infused into the withdrawn water by generating nanobubbles of the gas within the water. In some embodiments, the withdrawn water may be communicated to a nanobubble generator 12 which may infuse the gas containing oxygen into the water by generating nanobubbles of the gas within the water. Preferably, an oxygen concentrator 13 and an air compressor 14 may provide the gas containing oxygen and to the nanobubble generator 12 which may then disperse nanobubbles of the gas containing oxygen into the water. In preferred embodiments, the nanobubbles may be sized less than approximately 800 nanometers (nm), more preferably sized less than approximately 500 nanometers (nm), and more preferably sized less than approximately 200 nanometers (nm). In further preferred embodiments, the nanobubbles may be generated in the water at concentrations over approximately 1.0 x 10^5 nanobubbles per milliliter, and more preferably at concentrations over approximately 1.0 x 10^8 nanobubbles per milliliter. In further preferred embodiments, the gas containing oxygen may have oxygen gas at a concentration of greater than approximately 90 percent by volume, more preferably at a concentration of greater than approximately 93% by volume, and still more preferably at a concentration of greater than approximately 95% by volume. In still further embodiments, the nanobubbles may be generated by a nanobubble generator 12 that may be coupled to a portable platform 71 having a ball-mounted hitch 72. In still further embodiments, the gas containing oxygen may be supplied to the nanobubble generator 12 by an oxygen generator 13 that is coupled to a portable platform 71 having a ball-mounted hitch 72. In yet further embodiments, the water may be withdrawn from the water body 99 via an intake pump in step 202, and the intake pump 15 may be interlocked to only operate when the gas containing oxygen supplied to the nanobubble generator 12 has a gas pressure at a minimum of approximately 10 pound per square inch.

In step 503, a gas containing ozone may be infused into the withdrawn water by generating nanobubbles of the gas within the water. In some embodiments, the withdrawn water may be communicated to a nanobubble generator 12 which may infuse the gas containing into the water by generating nanobubbles of the gas within the water. An ozone generator 20 may provide a gas containing ozone to a nanobubble generator 12. Preferably, an oxygen concentrator 13 and an air compressor 14 may provide a gas containing oxygen to the ozone generator 20, and the ozone generator 20 may use the gas containing oxygen to generate a gas containing ozone that the nanobubble generator 12 may then use to disperse nanobubbles of the gas containing ozone into the water. In preferred embodiments, the nanobubbles may be sized less than approximately 800 nanometers (nm), more preferably sized less than approximately 500 nanometers (nm), and more preferably sized less than approximately 200 nanometers (nm). In further preferred embodiments, the nanobubbles may be generated in the water at concentrations over approximately 1.0 x 10^5 nanobubbles per milliliter, and more preferably at concentrations over approximately 1.0 x 10^8 nanobubbles per milliliter. In further preferred embodiments, the gas containing oxygen may have oxygen gas at a concentration of greater than approximately 90 percent by volume, more preferably at a concentration of greater than approximately 93% by volume, and still more preferably at a concentration of greater than approximately 95% by volume. In still further embodiments, the nanobubbles may be generated by a nanobubble generator 12 that may be coupled to a portable platform 71 having a ball-mounted hitch 72. In still further embodiments, the gas containing ozone may be supplied to the nanobubble generator 12 by an ozone generator 20 that is coupled to a portable platform 71 having a ball-mounted hitch 72. In yet further embodiments, the water may be withdrawn from the water body 99 via an intake pump in step 202, and the intake pump 15 may be interlocked to only operate when the gas containing ozone supplied to the nanobubble generator 12 has a gas pressure at a minimum of approximately 10 pound per square inch.

In step 505, the infused water may be returned into the water body 99. In preferred embodiments, the infused water is returned to the bottom of the water body 99. Generally, the bottom of a water body 99 may refer to any depth greater than approximately three feet below the surface of the water body 99. After step 505 the method 500 may finish 506.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for water body algae control in a water body, the method comprising:
withdrawing water from the water body;
infusing a gas into the withdrawn water by generating nanobubbles of the gas within the water, wherein the gas comprises at least one of a gas containing oxygen and a gas containing ozone; and
returning the infused water into the water body.

2. The method of claim 1, wherein a gas containing oxygen is infused into the withdrawn water, and wherein the oxygen concentration in the gas containing oxygen is at least 93% on a volume basis.

3. The method of claim 1, wherein the nanobubbles are sized less than 200 nanometers in diameter.

4. The method of claim 1, wherein the nanobubbles are generated at concentrations over 1.0 x 10^8 nanobubbles per milliliter of water.

5. The method of claim 1, wherein the nanobubbles are generated via a nanobubble generator.

6. The method of claim 5, wherein the nanobubble generator is coupled to a portable platform having a ball-mounted hitch.

7. The method of claim 1, wherein the water is withdrawn from the water body via an intake pump that is positioned on the bottom of the water body.

8. The method of claim 1, wherein the infused water is returned to the bottom of the water body.

9. The method of claim 1, wherein the gas containing oxygen is supplied to a nanobubble generator by an oxygen generator that is coupled to a portable platform having a ball-mounted hitch.

10. The method of claim 1, wherein a gas containing ozone is infused into the withdrawn water, and wherein the gas containing ozone is supplied to a nanobubble generator by an ozone generator that is coupled to a portable platform having a ball-mounted hitch.

11. A water body algae control system, the system comprising:
a nanobubble generator configured to receive water that is withdrawn from a water body; and
an oxygen concentrator and an air compressor configured to provide a gas containing oxygen to the nanobubble generator, wherein the nanobubble generator is configured to disperse nanobubbles of the gas containing oxygen into the water, and wherein the nanobubble containing water is then directed back into the water body.

12. The system of claim 11, further comprising an ozone generator that is configured to provide a gas containing ozone to the nanobubble generator, and wherein the nanobubble generator is configured to disperse nanobubbles of the gas containing ozone along with the nanobubbles of gas containing oxygen into the water, and wherein the nanobubble containing water is then directed back into the water body.

13. The system of claim 11, wherein the oxygen concentration in the gas containing oxygen is at least 93% on a volume basis.

14. The system of claim 11, wherein the nanobubbles are sized less than 200 nanometers in diameter.

15. The system of claim 11, wherein the nanobubbles are generated at concentrations over 1.0 x 10^8 nanobubbles per milliliter of water.

16. The system of claim 12, wherein the nanobubble generator, ozone generator, oxygen concentrator, and air compressor are coupled to a portable platform having a ball-mounted hitch.

17. The system of claim 11, wherein the water is withdrawn from the water body via an intake pump that is positioned on the bottom of the water body.

18. The system of claim 11, wherein the nanobubble containing water is returned to the bottom of the water body.

19. The system of claim 12, wherein the water is withdrawn from the water body via an intake pump, and wherein the intake pump is interlocked to operate when a gas provided to the nanobubble generator has a gas pressure at a minimum of 10 pounds per square inch, the gas selected from a gas containing oxygen and a gas containing ozone.

20. The system of claim 11, further comprising a dissolved oxygen sensor that is configured to measure the dissolved oxygen in the water that is withdrawn from the water body, and further comprising a control unit that is in communication with the dissolved oxygen sensor, wherein a client device is in communication with a network interface of the control unit, and wherein the control unit is configured to communicate data describing the dissolved oxygen in the water to the client device.
